(19) United States
(12) Patent Application Publication
(10) Pub. No.: US 2015/0266778 A1
(43) Pub. Date: Sep. 24, 2015

(54) GRANITE-LIKE COMPOSITE MATERIALS AND METHODS OF PREPARATION THEREOF

(71) Applicants: Richard E. Riman, Belle Mead, NJ (US); Dawid Zambrzycki, South River, NJ (US)

(72) Inventors: Richard E. Riman, Belle Mead, NJ (US); Dawid Zambrzycki, South River, NJ (US)

(73) Assignee: RUTGERS, THE STATE UNIVERSITY OF NEW JERSEY, NEW BRUNSWICK, NJ (US)

(21) Appl. No.: 14/045,519

(22) Filed: Oct. 3, 2013

Related U.S. Application Data
(60) Provisional application No. 61/709,435, filed on Oct. 4, 2012.

(51) Int. Cl. C04B 28/24; B28B 1/14; B28B 11/24; C04B 14/04

(52) U.S. Cl. CPC C04B 28/24; C04B 14/04; B28B 1/14; B28B 11/245

(57) ABSTRACT

The invention provides novel granite-like composite materials and methods for preparation thereof. The granite-like composite materials can be readily produced from widely available, low cost precursor materials by a process suitable for large-scale production. The precursor materials include calcium silicate, for example, wollastonite, and particulate filler materials which comprise silicon dioxide-rich materials such as quartz, mica, feldspar, sand and glass. Additives can include calcium carbonate-rich and magnesium carbonate-rich materials. Various additives can be used to fine-tune the physical appearance and mechanical properties of the composite material, such as colorants such as particles of colored materials, such as colored glass, colored sand, and colored quartz particles, and pigments (e.g., black iron oxide, cobalt oxide and chromium oxide). These granite-like composite materials exhibit visual patterns unique to granite as well as display compressive strength, flexural strength and water absorption similar to that of granite.

### CROSS-REFERENCE TO RELATED APPLICATIONS

This application claims priority to and the benefit of co-pending U.S. provisional patent application Ser. No. 61/709,435, filed Oct. 4, 2012, which application is incorporated herein by reference in its entirety.

### FIELD OF THE INVENTION

The invention generally relates to novel composite materials that exhibit granite-like aesthetic and physical characteristics. More particularly, the invention relates to synthetic granite-like materials and their preparation from a variety of low-cost raw materials including water and carbon dioxide. These composite materials are suitable for a variety of uses in construction, infrastructure, art and decoration.

### BACKGROUND OF THE INVENTION

Granite is an igneous rock comprising principally quartz, mica and feldspar. It usually has coarse grains within a fine-grained matrix. It is known to occur in nature with various coloration.

Humans have known and used granite since ancient times. Its unique aesthetic and physical qualities have made granite a desirable material in building and construction as well as in decorative art and sculpture. Artificial granite-like materials have been studied in efforts to replace the expensive and scarce material with low-cost, readily produced mimics. Such efforts, however, have yet to produce in a synthetic material that possesses the desired appearance, texture, density, hardness, porosity and other aesthetics characteristic of granite while at the same can be manufactured in large quantities at low cost with minimal environmental impact.

Most artificial granite mimics are prepared by blending natural stone powder and minerals with a synthetic resin (e.g., acrylic, unsaturated polyester, epoxy). These methods suffer from a number of deficiencies, including poor reproducibility, low yield, deterioration, high finishing costs, unsatisfactory mechanical properties, etc.

Furthermore, existing methods typically involve large energy consumption and carbon dioxide emission with unfavorable carbon footprint.

There is an on-going need for novel composite materials that exhibit granite-like aesthetic and physical characteristics and can be mass-produced at low cost with improved energy consumption and desirable carbon footprint.

### SUMMARY OF THE INVENTION

The invention is based in part on the unexpected discovery of novel granite-like composite materials that can be readily produced from widely available, low cost raw materials in particle form by a process suitable for large-scale production. The raw materials include particulate precursor materials that comprise particulate calcium silicate (e.g., ground wollastonite) that become bonding elements, and particulate filler materials that include minerals (e.g., quartz and other SiO₂-bearing materials, mica and feldspar). A fluid component is also provided as a reaction medium, comprising liquid water and/or water vapor and a reagent, carbon dioxide (CO₂). Additive materials can include natural or recycled materials, and calcium carbonate-rich and magnesium carbonate-rich materials, as well as additives to the fluid component, such as a water-soluble dispersant. Various additives can be used to fine-tune the physical appearance and mechanical properties of the resulting composite material, such as particles of colored materials, such as colored glass, colored sand, and colored quartz particles, and pigments (e.g., black iron oxide, cobalt oxide and chromium oxide). One can use the term “colorants” to refer generally to either or both of colored materials and pigments. In order to simulate a granite-like appearance, the particulate filler materials can include coarse particles and fine particles. The coarse particles are principally SiO₂ based materials in order to provide hardness, and the fine particles can be a wide variety of materials, including sand, ground, crushed or otherwise comminuted substances selected from minerals and additive materials.

These granite-like composite materials exhibit visual patterns unique to granite as well as display compressive strength, flexural strength and water absorption similar to that of granite. In addition, the composite materials of the invention can be produced using the efficient gas-assisted hydrothermal liquid phase sintering (HLPS) process at low cost and with much improved energy consumption and carbon footprint. In fact, in preferred embodiments of the invention, CO₂ is consumed as a reactive species resulting in net sequestration of CO₂.

In one aspect, the invention generally relates to a composite material that includes a plurality of bonding elements and a plurality of filler particles. Each bonding element includes a core comprising primarily calcium silicate, a silica-rich first or inner layer, and a calcium carbonate-rich second or outer (encapsulating) layer. The plurality of bonding elements and the plurality of filler particles together form one or more bonding matrices, and the bonding elements and the filler particles are substantially evenly dispersed therein and bonded together. The composite material exhibits one or more substantially granite-like textures, patterns and physical properties.

In another aspect, the invention generally relates to a process for preparing a composite material. The process includes: mixing a particulate composition and a liquid composition to form a slurry mixture; casting the slurry mixture in a mold; and curing the casted mixture at a temperature in the range from about 20° C. to about 150° C. for about 1 hour to about 80 hours under a vapor comprising water and CO₂ and having a pressure in the range from about ambient atmospheric pressure to about 50 psi above ambient atmospheric pressure and having a CO₂ concentration ranging from about 10% to about 90% to produce a composite material exhibiting a granite-like texture and pattern. The liquid composition includes water and a water-soluble dispersant. The process can further include, before curing the casted mixture, the step of drying the casted mixture.

The particulate composition includes a ground calcium silicate having a median particle size in the range from about 1 μm to about 100 μm, and a ground SiO₂ bearing material having a median particle size in the range from about 3 μm to about 7 mm. The liquid composition includes water and a water-soluble dispersant.

In yet another aspect, the invention generally relates to a composite material that includes: a plurality of bonding elements and a plurality of filler particles. Each bonding element includes: a core comprising primarily magnesium silicate, a silica-rich first or inner layer, and a magnesium carbonate-rich second or outer layer. The plurality of bonding elements and the plurality of filler particles together form one or more bonding matrices and the bonding elements and the filler particles are substantially evenly dispersed therein and bonded together, whereby the composite material exhibits one or more substantially granite-like textures, patterns and physical properties.

According to one aspect, the invention features a composite material. The composite material comprises a plurality of bonding elements, wherein each bonding element comprises: a core comprising primarily calcium silicate, a silica-rich first or inner layer, and a calcium carbonate-rich second or outer layer; and a plurality of filler particles comprising coarse filler particles and fine filler particles, wherein the plurality of bonding elements and the plurality of filler particles together form one or more bonding matrices and the bonding elements and the filler particles are substantially evenly dispersed therein and bonded together, whereby the composite material exhibits one or more substantially granite-like textures, patterns and physical properties.

In one embodiment, the composite material further comprises a colorant.

In another embodiment, the colorant is a pigment comprising a metal oxide.

In yet another embodiment, the colorant is a glass material having a color selected from black, white, blue, gray, pink, green, red, yellow and brown.

In still another embodiment, the plurality of bonding elements have a median particle size in the range from about 5 μm to about 100 μm.

In a further embodiment, the coarse filler particles are made from a silicon dioxide-rich material.

In yet a further embodiment, the plurality of filler particles comprise one or more of quartz, mica and feldspar.

In an additional embodiment, the plurality of bonding elements are chemically transformed from ground wollastonite.

In one more embodiment, the plurality of bonding elements are chemically transformed from a precursor calcium silicate other than wollastonite.

In still a further embodiment, the plurality of bonding elements are chemically transformed from a precursor calcium silicate comprising one or more of aluminum, magnesium and iron.

In one embodiment, the pigment comprises one or more of iron oxide, cobalt oxide and chromium oxide.

In another embodiment, the weight ratio of bonding elements:filler particles is about 15-50:50-85.

In yet another embodiment, the pigment is present in an amount from 0% to about 10% by weight.

In still another embodiment, the plurality of bonding elements are prepared by chemical transformation from ground wollastonite by reacting it with CO₂ via a controlled hydrothermal liquid phase sintering process.

In a further embodiment, the plurality of bonding elements are prepared by chemical transformation from the precursor calcium silicate other than wollastonite by reacting it with CO₂ via a controlled hydrothermal liquid phase sintering process.

In yet a further embodiment, the composite material has a compressive strength from about 90 MPa to about 175 MPa and a flexural strength from about 5.4 MPa to about 20.6 MPa.

In an additional embodiment, the composite material has a water absorption of less than about 10%.

In one more embodiment, the composite material exhibits a visual pattern unique to granite.

According to another aspect, the invention relates to a process for preparing a composite material. The process comprises the steps of mixing a particulate composition and a liquid composition to form a slurry mixture, wherein the particulate composition comprises: a ground calcium silicate having a median particle size in the range from about 1 μm to about 100 μm, and a plurality of filler particles comprising coarse particles and fine particles, and wherein the liquid composition comprises: water, and a water-soluble dispersant; casting the slurry mixture in a mold; and curing the casted mixture at a temperature in the range from about 20° C. to about 150° C. for about 1 hour to about 80 hours under an atmosphere of water and CO₂ having a pressure in the range from ambient atmospheric pressure to about 60 psi above ambient and having a CO₂ concentration ranging from about 10% to about 90% to produce a composite material exhibiting a granite-like texture and pattern.

In one embodiment, the process further comprises, before the step of curing the casted mixture the step of drying the casted mixture.

In another embodiment, the particulate composition further comprises a colorant.

In yet another embodiment, the step of curing the casted mixture is performed at a temperature in the range from about 60° C. to about 110° C. for about 15 hours to about 70 hours under a vapor comprising water and CO₂ and having a pressure in the range from about ambient atmospheric pressure to about 30 psi above ambient atmospheric pressure.

In still another embodiment, the step of curing the casted mixture is performed at a temperature in the range from about 60° C. to about 100° C. for about 20 hours to about 60 hours under a vapor comprising water and CO₂ and having a pressure in the range from about ambient atmospheric pressure to about 30 psi above ambient atmospheric pressure.

In a further embodiment, the step of curing the casted mixture is performed at a temperature equal to or lower than about 60° C. for about 15 to about 50 hours under a vapor comprising water and CO₂ and having an ambient atmospheric pressure.

In yet a further embodiment, the ground calcium silicate comprises ground wollastonite, and the plurality of filler particles comprising coarse particles and fine particles comprise a silicon dioxide-rich material.

In an additional embodiment, the ground wollastonite has a median particle size from about 5 μm to about 50 μm, a bulk density from about 0.6 g/mL to about 0.8 g/mL (loose) and about 1.0 g/mL to about 1.2 g/mL (tapped), a surface area from about 1.5 m²/g to about 2.0 m²/g.

In one more embodiment, the plurality of filler particles comprising coarse particles and fine particles comprise one or more of quartz, mica and feldspar.

In still a further embodiment, the particulate composition comprises a pigment comprising a metal oxide.

In one embodiment, the particulate composition comprises a glass material having a color selected from black, white, blue, gray, pink, green, red, yellow and brown.

In another embodiment, the liquid composition comprises water, and a water-soluble dispersant comprising a polymer salt having a concentration from about 0.1% to about 2% w/w of the liquid composition.

In yet another embodiment, the polymer salt is an acrylic homopolymer salt.

In still another embodiment, the particulate composition comprises about 25% w/w of ground calcium silicate, and about 70% to about 75% w/w of the silicon dioxide-based material.

In a further embodiment, the ground calcium silicate is primarily ground wollastonite and the silicon dioxide-based material is primarily a material selected from the group consisting of glass, quartz and sand.

In yet a further embodiment, the invention relates to a composite material prepared by any of the preceding processes.

In an additional embodiment, the composite material has a compressive strength from about 90 MPa to about 175 MPa and a flexural strength from about 5.4 MPa to about 20.6 MPa.

In one more embodiment, the composite material has a water absorption of less than about 10%.

In still a further embodiment, the composite material comprises a colorant having a color selected from black, white, blue, gray, pink, green, red, yellow and brown.

In one embodiment, the composite material exhibits a visual pattern unique to granite.

According to another aspect, the invention features an article of manufacture made from a composite material as described hereinabove.

According to another aspect, the invention relates to a composite material.

The composite material comprises a plurality of bonding elements, wherein each bonding element comprises: a core comprising primarily magnesium silicate, a silica-rich first or inner layer, and a magnesium carbonate-rich second or outer layer; and a plurality of filler particles, wherein the plurality of bonding elements and the plurality of filler particles together form one or more bonding matrices and the bonding elements and the filler particles are substantially evenly dispersed therein and bonded together, whereby the composite material exhibits one or more substantially granite-like textures, patterns and physical properties.

### BRIEF DESCRIPTION OF THE DRAWINGS

FIGS. 1(a)-1(c) are schematic illustrations of cross-sections of bonding elements according to exemplary embodiments of the present invention, including three exemplary core morphologies: (a) fibrous, (b) elliptical, and (c) equiaxed.

FIGS. 2(a)-2(f) are schematic illustrations of side view and cross section views of composite materials according to exemplary embodiments of the present invention, illustrating (a) 1D oriented fiber-shaped bonding elements in a dilute bonding matrix (bonding elements are not touching), (b) 2D oriented platelet shaped bonding elements in a dilute bonding matrix (bonding elements are not touching), (c) 3D oriented platelet shaped bonding elements in a dilute bonding matrix (bonding elements are not touching), and (d) randomly oriented platelet shaped bonding elements in a dilute bonding matrix (bonding elements are not touching), wherein the composite materials includes the bonding matrix and filler components such as polymers, metals, inorganic particles, aggregates etc., (e) a concentrated bonding matrix (with a volume fraction sufficient to establish a percolation network) of bonding elements where the matrix is 3D oriented, and (f) a concentrated bonding matrix (with a volume fraction sufficient to establish a percolation network) of randomly oriented bonding elements, wherein filler components such as polymers, metals, inorganic particles, aggregates etc. may be included.

FIG. 3 shows an exemplary photograph of a synthetic caramel quartz granite prepared according to an embodiment of the present invention.

FIG. 4 shows a Golden Crema® granite slab acquired from Fairfield County Stone, Bridgeport, Conn.

FIG. 5 shows an exemplary photograph of a synthetic green quartz granite prepared according to an embodiment of the present invention.

### DETAILED DESCRIPTION OF THE INVENTION

This invention provides novel composite materials that exhibit granite-like properties and can be readily produced from widely available, low cost raw materials by a process suitable for large-scale production with minimal environmental impact. The raw materials include inexpensive calcium silicate, for example, ground wollastonite, and coarse particles and fine particles. The coarse particles and the fine particles are principally SiO₂ based materials in order to provide hardness. The coarse and fine particles can include minerals (e.g., quartz and other SiO₂-bearing materials, mica and feldspar). Other key process components include water and CO₂. Various additives can be used to modify and fine-tune the physical appearance and/or mechanical properties of the resulting composite material, such as using pigments (e.g., black iron oxide, cobalt oxide and chromium oxide) and colored glass and/or colored quartz.

These composite materials display various granite-like patterns, textures and other characteristics, such as visual patterns of various colors that are unique to granite. In addition, the composite materials of the invention exhibit compressive strength, flexural strength and water absorption similar to that of granite. Furthermore, the composite materials can be produced, as disclosed herein, using the energy-efficient HLPS process and can be manufactured at low cost and with favorable environmental impact. For example in preferred embodiments of the invention, CO₂ is used as a reactive species resulting in sequestration of CO₂ in the produced composite materials with in a carbon footprint unmatched by any existing production technology. The HLPS process is thermodynamically driven by the free energy of the chemical reaction(s) and reduction of surface energy (area) caused by crystal growth. The kinetics of the HLPS process proceed at a reasonable rate at low temperature because a solution (aqueous or nonaqueous) is used to transport reactive species instead of using a high melting point fluid or high temperature solid-state medium.

Discussions on various aspects of HLPS can be found in U.S. Pat. No. 8,114,367, U.S. Pub. No. US 2011/0104469 (application Ser. No. 12/984,299), U.S. Pub. No. 20090142578 (application Ser. No. 12/271,513), WO 2009/102360 (PCT/US2008/083606), WO 2011/053598 (PCT/US2010/054146), WO 2011/090967 (PCT/US2011/021623), U.S. application Ser. No. 13/411,218 filed Mar. 2, 2012 (Riman et al.), U.S. application Ser. No. 13/491,098 filed Jun. 7, 2012 (Riman et al), and U.S. Provisional Patent Application No. 61/708,423 filed Oct. 1, 2012, each of which is expressly incorporated herein by reference in its entirety for all purposes.

In one aspect, the invention generally relates to a composite material that includes a plurality of bonding elements and a plurality of filler particles. Each bonding element includes a core comprising primarily calcium silicate, a silica-rich first or inner layer, and a calcium carbonate-rich second or outer layer. The plurality of bonding elements and the plurality of filler particles together form one or more bonding matrices and the bonding elements and the filler particles are substantially evenly dispersed therein and bonded together. The composite material exhibits one or more substantially granite-like textures, patterns and physical properties.

In certain embodiments, the composite further includes a pigment. The pigment may be evenly dispersed or substantially unevenly dispersed in the bonding matrices, depending on the desired composite material. The pigment may be any suitable pigment including, for example, oxides of various metals (e.g., iron oxide, cobalt oxide, chromium oxide) The pigment may be of any color or colors, for example, selected from black, white, blue, gray, pink, green, red, yellow and brown. The pigment may be present in any suitable amount depending on the desired composite material, for example in an amount ranging from about 0.0% to about 10% by weight (e.g., about 0.0% to about 8%, about 0.0% to about 6%, about 0.0% to about 5%, about 0.0% to about 4%, about 0.0% to about 3%, about 0.0% to about 2%, about 0.0% to about 1%, about 0.0% to about 0.5%, about 0.0% to about 0.3%, about 0.0% to about 2%, about 0.0% to about 0.1%,).

The plurality of bonding elements may have any suitable median particle size and size distribution dependent on the desired composite material. In certain embodiments, the plurality of bonding elements have a median particle size in the range of about 5 μm to about 100 μm (e.g., about 5 μm to about 80 μm, about 5 μm to about 60 μm, about 5 μm to about 50 μm, about 5 μm to about 40 μm, about 5 μm to about 30 μm, about 5 μm to about 20 μm, about 5 μm to about 10 μm, about 10 μm to about 80 μm, about 10 μm to about 70 μm, about 10 μm to about 60 μm, about 10 μm to about 50 μm, about 10 μm to about 40 μm, about 10 μm to about 30 μm, about 10 μm to about 20 μm).

The plurality of filler particles may have any suitable median particle size and size distribution. In certain embodiments, the plurality of filler particles has a median particle size in the range from about 5 μm to about 7 mm (e.g., about 5 μm to about 5 mm, about 5 μm to about 4 mm, about 5 μm to about 3 mm, about 5 μm to about 2 mm, about 5 μm to about 1 mm, about 5 μm to about 500 μm, about 5 μm to about 300 μm, about 20 μm to about 5 mm, about 20 μm to about 4 mm, about 20 μm to about 3 mm, about 20 μm to about 2 mm, about 20 μm to about 1 mm, about 20 μm to about 500 μm, about 20 μm to about 300 μm, about 100 μm to about 5 mm, about 100 μm to about 4 mm, about 100 μm to about 3 mm, about 100 μm to about 2 mm, about 100 μm to about 1 mm).

In certain preferred embodiments, the filler particles are made from one or more of SiO2-based or silicate-based material such as quartz (SiO₂), mica (aluminum silicate) and feldspar (aluminum silicate-based material) (e.g., ground quartz, ground mica, ground feldspar).

In certain embodiments, filler particles may include natural, synthetic and recycled materials such as glass, recycled glass, coal slag, calcium carbonate-rich material and magnesium carbonate-rich material.

The plurality of bonding elements may be chemically transformed from any suitable precursor materials, for example, from a precursor calcium silicate other than wollastonite. The precursor calcium silicate may include one or more chemical elements of aluminum, magnesium and iron.

As used herein, the term “calcium silicate” refers to naturally-occurring minerals or synthetic materials that are comprised of one or more of a group of calcium-silicon-containing compounds including CaSiO₃ (also known as “wollastonite” and sometimes formulated as CaO.SiO₂), Ca₂SiO₄ (also known as “Belite” and sometimes formulated as 2CaO.SiO₂), Ca₃SiO₅ (also known as “Alite” and sometimes formulated as 3CaO.SiO₂), which material may include one or more other metal ions and oxides (e.g., aluminum, magnesium, iron or manganese oxides), or blends thereof, or may include an amount of magnesium silicate in naturally-occurring or synthetic form(s) ranging from trace amount (1%) to about 50% or more by weight.

It should be understood that, compositions and methods disclosed herein can be adopted to use magnesium silicate in place of or in addition to calcium silicate. As used herein, the term “magnesium silicate” refers to nationally-occurring minerals or synthetic materials that are comprised of one or more of a groups of magnesium-silicon-containing compounds including, for example, Mg₂SiO₄ (also know as “Fosterite”) and Mg₃Si₄O₁₀(OH)₂) (also known as “Talc”), which material may include one or more other metal ions and oxides (e.g., calcium, aluminum, iron or manganese oxides), or blends thereof, or may include an amount of calcium silicate in naturally-occurring or synthetic form(s) ranging from trace amount (1%) to about 50% or more by weight.

The term “quartz”, as used herein, refers to any SiO₂-based material, including common sands (construction and masonry), as well as glass and recycled glass. The term also includes any other recycled natural and synthetic materials that contain significant amounts of SiO₂ (e.g., mica sometimes formulated as KAl₂(AlSi₃O₁₀)).

The weight ratio of (bonding elements):(filler particles) may be any suitable rations dependent on the desired composite material, for example, in the range of about (15 to 50):about (50 to 85).

In certain preferred embodiments, the plurality of bonding elements are prepared by chemical transformation from ground wollastonite (or a non-wollastonite precursor calcium silicate or magnesium silicate) by reacting it with CO₂ via a gas-assisted HLPS process.

In certain embodiments, the composite material is characterized by a compressive strength from about 100 MPa to about 300 MPa (e.g., about 100 MPa to about 250 MPa, about 100 MPa to about 200 MPa, about 100 MPa to about 180 MPa, about 100 MPa to about 160 MPa, about 100 MPa to about 150 MPa, about 100 MPa to about 140 MPa, about 120 MPa to about 300 MPa, about 130 MPa to about 300 MPa, about 140 MPa to about 300 MPa, about 150 MPa to about 300 MPa, about 200 to about 300 MPa).

In certain embodiments, the composite material is characterized by a flexural strength from about 15 MPa to about 40 MPa (e.g., about 15 MPa to about 35 MPa, about 15 MPa to about 30 MPa, about 15 MPa to about 25 MPa, about 15 MPa to about 20 MPa, about 20 MPa to about 40 MPa, about 20 MPa to about 35 MPa, about 20 MPa to about 30 MPa).

In certain embodiments, the composite material is characterized by water absorption of less than about 10% (e.g., less than about 8%, 5%, 4%, 3%, 2%, 1%).

In certain embodiments, the composite material has less than about 10% by weight of one or more minerals selected from calcium carbonate and magnesium carbonate.

The composite material may display any desired textures, patterns and physical properties, in particular those that are characteristic of granite. In certain preferred embodiments, the composite material exhibits a visual pattern unique to granite. Other granite-like characteristics include colors (e.g., black, white, blue, gray, pink, green, red, yellow, brown) and textures.

In another aspect, the invention generally relates to a process for preparing a composite material. The process includes: mixing a particulate composition and a liquid composition to form a slurry mixture; casting the slurry mixture in a mold; and curing the casted mixture at a temperature in the range from about 20° C. to about 150° C. for about 1 hour to about 80 hours under a vapor comprising water and CO₂ and having a pressure in the range from about ambient atmospheric pressure to about 50 psi above ambient atmospheric pressure and having a CO₂ concentration ranging from about 10% to about 90% to produce a composite material exhibiting a granite-like texture and pattern.

The particulate composition includes a ground calcium silicate having a median particle size in the range from about 1 μm to about 100 μm, and a ground SiO₂ bearing material having a median particle size in the range from about 3 μm to about 7 mm. The liquid composition includes water and a water-soluble dispersant.

The process can further include, before curing the casted mixture, the step of drying the casted mixture. The particulate composition further comprises a pigment or a colorant as discussed herein.

In certain embodiments, curing the casted mixture is performed at a temperature in the range from about 40° C. to about 120° C. for about 5 hours to about 70 hours under a vapor comprising water and CO₂ and having a pressure in the range from about ambient atmospheric pressure to about 30 psi above ambient atmospheric pressure.

In certain embodiments, curing the casted mixture is performed at a temperature in the range from about 60° C. to about 110° C. for about 15 hours to about 70 hours under a vapor comprising water and CO₂ and having a pressure in the range from about ambient atmospheric pressure to about 30 psi above ambient atmospheric pressure.

In certain embodiments, curing the casted mixture is performed at a temperature in the range from about 80° C. to about 100° C. for about 20 hours to about 60 hours under a vapor comprising water and CO₂ and having a pressure in the range from about ambient atmospheric pressure to about 30 psi above ambient atmospheric pressure.

In certain embodiments, curing the casted mixture is performed at a temperature equal to or lower than about 60° C. for about 15 to about 50 hours under a vapor comprising water and CO₂ and having an ambient atmospheric pressure.

For example, in some embodiments, the ground wollastonite has a median particle size from about 5 μm to about 50 μm (e.g., about 5 μm, 10 μm, 15 μm, 20 μm, 25 μm, 30 μm, 40 μm, 90 μm), a bulk density from about 0.6 g/mL to about 0.8 g/mL (loose) and about 1.0 g/mL to about 1.2 g/mL (tapped), a surface area from about 1.5 m²/g to about 2.0 m²/g. The first ground SiO₂ bearing material has a median particle size from about 40 μm to about 90 μm (e.g., about 40 μm, 50 μm, 60 μm, 70 μm, 80 μm, 30 μm, 90 μm), a bulk density from about 0.7 g/mL to about 0.9 g/mL (loose) and about 1.3 g/mL to about 1.6 g/mL (tapped).

In certain preferred embodiments, the liquid composition includes water and a water-soluble dispersant comprising a polymer salt (e.g., an acrylic homopolymer salt) having a concentration from about 0.1% to about 2% w/w of the liquid composition.

In yet another aspect, the invention generally relates to a composite material prepared according to a process disclosed herein, for example, a composite material having a compressive strength from about 100 MPa to about 300 MPa and a flexural strength from about 15 MPa to about 40 MPa, having a water absorption of less than about 10%, having a pigment having a color selected from black, white, blue, gray, pink, green, red, yellow and brown and other colors not found in the natural analog, and/or exhibiting a visual pattern unique to granite.

In yet another aspect, the invention generally relates to an article of manufacture made from a composite material disclosed herein.

Any suitable precursor materials may be employed. For example calcium silicate particles formed primarily of wollastonite, CaSiO₃, can react with carbon dioxide dissolved in water. It is believed that calcium cations are leached from the wollastonite and transform the peripheral portion of the wollastonite core into calcium-deficient wollastonite. As the calcium cations continue to be leached from the peripheral portion of the core, the structure of the peripheral portion eventually become unstable and breaks down, thereby transforming the calcium-deficient wollastonite peripheral portion of the core into a predominantly silica-rich first layer. Meanwhile, a predominantly calcium carbonate second layer precipitates from the water.

More specifically, the first layer and second layer may be formed from the precursor particle according the following reaction (1):

CaSiO₃(s)+CO₂(g)=CaCO₃(s)+SiO₂(s)ΔH°=−87 kJ/mol CO₂ (1)

For example, in a silicate mineral carbonation reaction such as with wollastonite, CO₂ is introduced as a gas phase that dissolves into an infiltration fluid, such as water. The dissolution of CO₂ forms acidic carbonic species that results in a decrease of pH in solution. The weakly acidic solution incongruently dissolves calcium species from CaSiO₃. The released calcium cations and the dissociated carbonate species lead to the precipitation of insoluble carbonates. Silica-rich layers are thought to remain on the mineral particles as depletion layers.

Thus, according to a preferred embodiment of the invention, CO₂ preferentially reacts with the calcium cations of the wollastonite precursor core, thereby transforming the peripheral portion of the precursor core into a silica-rich first layer and a calcium carbonate-rich second layer. Also, the presence of the first and second layers on the core act as a barrier to further reaction between wollastonite and carbon dioxide, resulting in the bonding element having the core, first layer and second layer.

In some embodiments, silicate materials having metals other than Ca or in addition to Ca, for example Fosterite (Mg₂SiO₄), Diopside (CaMgSi₂O₆), and Talc (Mg₃Si₄O₁₀(OH)₂) can react with carbon dioxide dissolved in water in a manner similar to reaction of wollastonite, as described above. It is believed that such silicate materials can be used, alone, in combination, and/or in combination with wollastonite, as precursors for bonding elements according to principles of the invention.

Preferably, gas-assisted HLPS processes utilize partially infiltrated pore space so as to enable gaseous diffusion to rapidly infiltrate the porous preform and saturate thin liquid interfacial solvent films in the pores with dissolved CO₂. CO₂-based species have low solubility in pure water (1.5 g/L at 25° C., 1 atm.). Thus, a substantial quantity of CO₂ must be continuously supplied to and distributed throughout the porous preform to enable significant carbonate conversion. Utilizing gas phase diffusion offers a huge (about 100-fold) increase in diffusion length over that of diffusing soluble CO₂ an equivalent time in a liquid phase. (“Handbook of chemistry and physics”, Editor: D. R. Lide, Chapters 6 and 8, 87^{th} Edition 2006-2007, CRC.) This partially infiltrated state enables the reaction to proceed to a high degree of carbonation in a fixed period of time.

Liquid water in the pores speeds up the reaction rate because it is essential for ionization of both carbonic acid and calcium species. However, water levels need to be low enough such that CO₂ gas can diffuse into the porous matrix prior to dissolution in the pore-bound water phase. Furthermore, the actively dissolving porous preform serves as a template for expansive reactive crystal growth. Thus, the bonding element and matrices can be formed with minimal distortion and residual stresses. This enables large and complex shapes to result, such as those needed for infrastructure and building materials, in addition to many other applications.

Thus, various combinations of curing conditions may be devised to achieve the desired production process, including varied reaction temperatures, pressures and lengths of reaction. In a first exemplary embodiment, water is delivered to the precursor materials in liquid form with CO₂ dissolved therein and the curing process is conducted at about 90° C. and about 20 psig (i.e., 20 psi above ambient pressure) for about 48 hours. In a second exemplary embodiment, water is present in the precursor material (e.g., as residual water from prior mixing step) and water vapor is provided to precursor materials (e.g., to maintain water level and/or prevent loss of water from evaporating) along with CO₂ and the curing process is performed at about 60° C. and 0 psig (at ambient atmospheric pressure) for about 19 hours. In a third exemplary embodiment, water is delivered to precursor materials in vapor form along with CO₂ and the curing process is performed at about 90° C. and 20 psig (20 psi above ambient atmospheric pressure) for about 19 hours.

In yet another aspect, the invention generally relates to a composite material that includes: a plurality of bonding elements and a plurality of filler particles. Each bonding element includes: a core comprising primarily magnesium silicate, a silica-rich first or inner layer, and a magnesium carbonate-rich second or outer layer. The plurality of bonding elements and the plurality of filler particles together form one or more bonding matrices and the bonding elements and the filler particles are substantially evenly dispersed therein and bonded together, whereby the composite material exhibits one or more substantially granite-like textures, patterns and physical properties.

Compositions and methods disclosed herein in connection with calcium silicate can be adopted to use magnesium silicate in place of or in addition to calcium silicate.

### Bonding Elements, Bonding Matrices and Composite Materials

### A. Bonding Elements

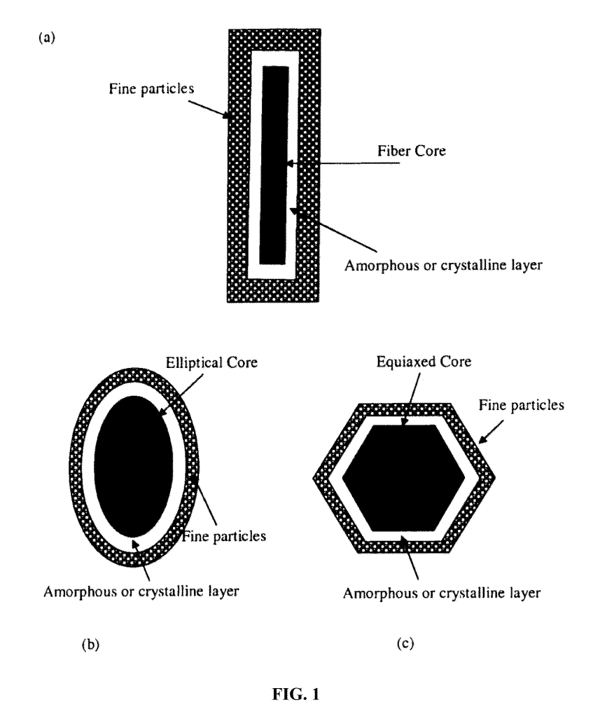

As schematically illustrated in FIGS. 1(a)-1(c), a bonding element includes a core (represented by the black inner portion), a first layer (represented by the white middle portion) and a second or encapsulating layer (represented by the outer portion). The first layer may include only one layer or multiple sub-layers and may completely or partially cover the core. The first layer may exist in a crystalline phase, an amorphous phase or a mixture thereof, and may be in a continuous phase or as discrete particles. The second layer may include only one layer or multiple sub-layers and may also completely or partially cover the first layer. The second layer may include a plurality of particles or may be of a continuous phase, with minimal discrete particles.

A bonding element may exhibit any size and any regular or irregular, solid or hollow morphology depending on the intended application. Exemplary morphologies include: cubes, cuboids, prisms, discs, pyramids, polyhedrons or multifaceted particles, cylinders, spheres, cones, rings, tubes, crescents, needles, fibers, filaments, flakes, spheres, sub-spheres, beads, grapes, granulars, oblongs, rods, ripples, etc.

In general, as discussed in greater detail herein, a bonding element is produced from reactive precursor materials (e.g., precursor particles) through a transformation process. The precursor particles may have any size and shape as long as they meet the needs of the intended application. The transformation process generally leads to the corresponding bonding elements having similar sizes and shapes of the precursor particles.

Precursor particles can be selected from any suitable material that can undergo suitable transformation to form the desired bonding elements. For example, the precursor particles may include oxides and non-oxides of silicon, titanium, aluminum, phosphorus, vanadium, tungsten, molybdenum, gallium, manganese, zirconium, germanium, copper, niobium, cobalt, lead, iron, indium, arsenic, tantalum, and/or alkaline earth elements (beryllium, magnesium, calcium, strontium, barium and radium).

Exemplary precursor materials include oxides such as silicates, titanates, aluminates, phosphates, vanadates, tungstates, molybdates, gallates, manganates, zirconates, germinates, cuprates, stannates, hafnates, chromates, niobates, cobaltates, plumbates, ferrites, indates, arsenates, tantalates and combinations thereof. In some embodiments, the precursor particles include silicates such as orthosilicates, sorosilicates, cyclosilicates, inosilicates, phyllosilicates, tectosilicates and/or calcium silicate hydrate.

Certain waste materials may be used as the precursor particles for some applications. Waste materials may include, for example, minerals, industrial waste, or an industrial chemical material. Some exemplary waste materials include mineral silicate, iron ore, periclase, gypsum, iron (II) huydroxide, fly ash, bottom ash, slag, glass, oil shells, red mud, battery waste, recycled concrete, mine tailings, paper ash, or salts from concentrated reverse osmosis brine.

Additional precursor particles may include different types of rock containing minerals such as cal-silicate rock, fitch formation, hebron gneiss, layered gneiss, middle member, argillite, quartzite, intermediate Precambrian sediments, dark-colored, feldpathic quartzite with minor limestone beds, high-grade metasedimentry biotite schist, biotite gniss, mica schist, quartzite, hoosac formation, partridge formation, Washington gneiss, Devonian, Silurian greenvale cove formation, ocoee supergroup, metasandstone, metagraywacke, Rangeley formation, amphibolites, calcitic and dolomite marble, manhattan formation, rusty and gray biotite-quartz-feldspar gneiss, and waterford group.

Precursor particles may also include igneous rocks such as, andesite, anorthosite, basinite, boninite, carbonatite and charnockite, sedimentary materials such as, but not limited to, argillite, arkose, breccias, cataclasite, chalk, claystone, chert, flint, gitsone, lighine, limestone, mudstone, sandstone, shale, and siltsone, metamorphic materials such as, but not limited to, amphibolites, epidiorite, gneiss, granulite, greenstone, hornfels, marble, pelite, phyllite, quartzite, shist, skarn, slate, talc carbonate, and soapstone, and other varieties of rocks such as, but not limited to, adamellite, appinite, aphanites, borolanite, blue granite, epidosite, felsites, flint, ganister, ijolite, jadeitite, jasproid, kenyte, vogesite, larvikite, litchfieldite, luxullianite, mangerite, minette, novaculite, pyrolite, rapakivi granite, rhomb porphyry, shonkinite, taconite, teschenite, theralite, and variolite.

Table 1 provides exemplary embodiments of different types of chemistries for the first and second layers that can be achieved when using different precursor materials. Regarding the first layer, by using different precursor materials one may obtain silica, alumina or titania. The second layer may also be modified with the selection of the precursor material. For example, the second layer may include various types of carbonates such as, pure carbonates, multiple cations carbonates, carbonates with water or an OH group, layered carbonates with either water or an OH group, anion containing carbonates, silicate containing carbonates, and carbonate-bearing minerals.

TABLE 1
Exemplary Precursors and Encapsulating layers

| Raw Material (Precursor) | First Layer | Encapsulating Layer |
|---|---|---|
| Wollastonite (CaSiO₃) | Silica- | CaCO₃ |
| Fosterite (Mg₂SiO₄) | rich | MgCO₃ |
| Diopside (CaMgSi₂O₆) | | (Ca, Mg)CO₃ |
| Talc (Mg₃Si₄O₁₀(OH)₂) | | MgCO₃xH₂O (x = 1-5) |
| Glaucophane | Alumina | MgCO₃ and/or |
| (Na₂Mg₃Al₂Si₈O₂₂(OH)₂) | and/or | NaAlCO₃(OH)₂ |
| Palygorskite | Silica- | Mg₆Al₂CO₃(OH)₁₆4H₂O |
| ((Mg, Al)₂Si₄O₁₀(OH)•4(H₂O)) | rich | |
| Meionite | | Ca₂SO₄CO₃•4H₂O |
| (Ca₄(Al₂Si₂O₈)₃(Cl₂CO₃, SO₄)) | | |
| Tanzanite | | Ca₅Si₂O₈CO₃ and/or |
| (Ca₂Al₃O(SiO₄)(Si₂O₇)(OH)) | | Ca₅Si₂O₈CO₃ and/or |
| | | Ca₇Si₆O₁₈CO₃•2H₂O |
| (Ba_{0.6}Sr_{0.3}Ca_{0.1})TiO₃ | Titania- | Sr(Sr, Ca, Ba)(CO₃)₂ |
| | rich | |

The second layer may be modified by introducing additional anions and/or cations. Such additional anions and cations may be used to modify the second layer to increase its physical and chemical properties such as fire resistance or acid resistance. For example, as shown in Table 2, while the first layer is retained as a silica-rich layer, the second layer may be modified by adding extra anions or cations to the reaction, such as PO₄²⁻ and SO₄²⁻. As a result, the second layer may include, for example, different phosphate, sulphate, fluoride or combinations thereof.

TABLE 2
Examples of Cation/Anion Sources (in addition to CO₃²⁻)

| Core | First | Extra anion/ | | |
|---|---|---|---|---|
| Particle | Layer | cation source | Encapsulating Layer | Carbonate Type |
| CaSiO₃ | Silica-rich | Phosphates | Ca₅(PO₄, CO₃)₃OH | Phosphate bearing carbonates |
| | layer | Sulphates | Ca₂SO₄CO₃•4H₂O | Sulphate bearing carbonates |
| | | Fluorides | Ca₂CO₃F₂ | Fluorides bearing carbonates |
| | | Phosphates and | Ca₅(PO₄, CO₃)₃F | Fluoride and phosphates bearing |
| | | fluorides | | carbonates |
| | | Mg⁺² source like | CaMg(CO₃)₂ | Multiple cation carbonates |
| | | chlorides, nitrates, | | |
| | | hydroxides etc. | | |
| | | A combination of | Ca₆Mg₂(SO₄)₂(CO₃)₂Cl₄(OH)₄•7H₂O | Post-1992 Carbonate-Bearing |
| | | cation and anion | | Minerals |
| | | sources | | |

### B. Bonding Matrix and Composite Material

A bonding matrix comprises a plurality of bonding elements, forming a three-dimensional network. The bonding matrix may be porous or non-porous. The degree of porosity depends on a number of variables that can be used to control porosity, such as temperature, reactor design, the precursor material and the amount of liquid that is introduced during the transformation process. Depending on the intended application, the porosity can be set to almost any degree of porosity from about 1 vol. % to about 99 vol. %.

The bonding matrix may incorporate one or more filler materials, which are mixed with the precursor materials prior to or during the transformation process to create the composite material. The concentration of bonding elements in the bonding matrix may vary. For example, the concentration of bonding elements on a volume basis may be relatively high, wherein at least some of the bonding elements are in contact with one another. This situation may arise if filler material is incorporated into the bonding matrix, but the type of filler material and/or the amount of filler material is such that the level of volumetric dilution of the bonding element is relatively low. In another example, the concentration of bonding elements on a volume basis may be relatively low, wherein the bonding elements are more widely dispersed within the bonding matrix such that few, if any of the bonding elements are in contact with one another. This situation may arise if filler material is incorporated into the bonding matrix, and the type of filler material and/or the amount of filler material is such that the level of dilution is relatively high.

In general, the filler material may include any one of a number of types of materials that can be incorporated into the bonding matrix. A filler material may be inert or active. An inert material does not go through any chemical reaction during the transformation and does not act as a nucleation site, although it may physically or mechanically interact with the bonding matrix. The inert material may involve polymers, metals, inorganic particles, aggregates, and the like. Specific examples may include, but are not limited to basalt, granite, recycled PVC, rubber, metal particles, alumina particle, zirconia particles, carbon-particles, carpet particles, Kevlar™ particles and combinations thereof. An active material chemically reacts with the bonding matrix during the transformation go through any chemical reaction during the transformation and/or acts as a nucleation site. For example, magnesium hydroxide may be used as a filler material and may chemically react with a dissolving calcium component phase from the bonding matrix to form magnesium calcium carbonate.

The bonding matrix may occupy almost any percentage of a composite material. Thus, for example, the bonding matrix may occupy about 1 vol. % to about 99 vol. % of the composite material (e.g., the volume fraction of the bonding matrix can be less than or equal to about 90 vol. %, 70 vol. %, 50 vol. %, 40 vol. %, 30 vol. %, 20 vol. %, 10 vol. %). A preferred range for the volume fraction of the bonding matrix is about 8 vol. % to about 90 vol. % (e.g., about 8 vol. % to about 80 vol. %, about 8 vol. % to about 70 vol. %, about 8 vol. % to about 50 vol. %, about 8 vol. % to about 40 vol. %), and more preferred range of about 8 vol. % to 30 vol. %.

A composite material may also be porous or non-porous. The degree of porosity depends on a number of variables that can be used to control porosity, such as temperature, reactor design, the precursor material, the amount of liquid that is introduced during the transformation process and whether any filler is employed. Depending on the intended application, the porosity can be set to almost any degree of porosity from about 1 vol. % to about 99 vol. % (e.g., less than or equal to about 90 vol. %, 70 vol. %, 50 vol. %, 40 vol. %, 30 vol. %, 20 vol. %, 10 vol. %). A preferred range of porosity for the composite material is about 1 vol. % to about 70 vol. %, more preferably between about 1 vol. % and about 10 vol. % for high density and durability and between about 50 vol. % and about 70 vol. % for lightweight and low thermal conductivity.

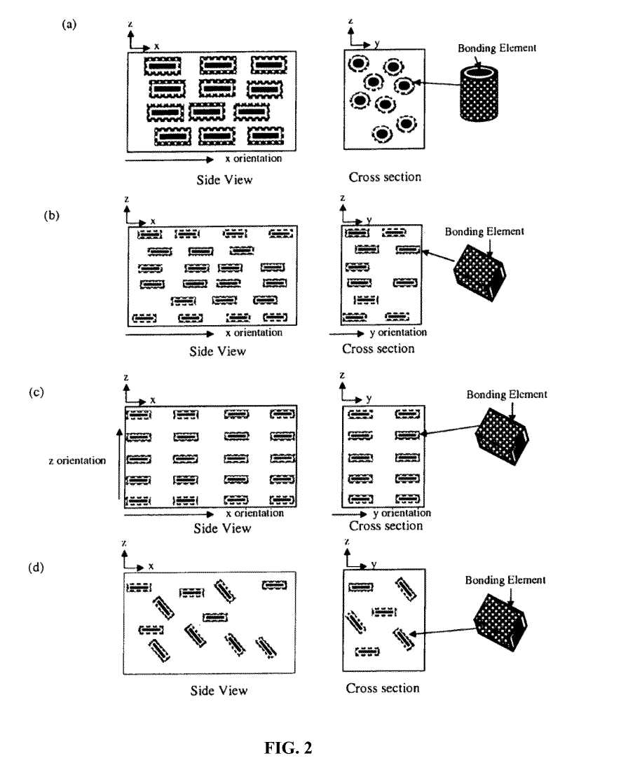

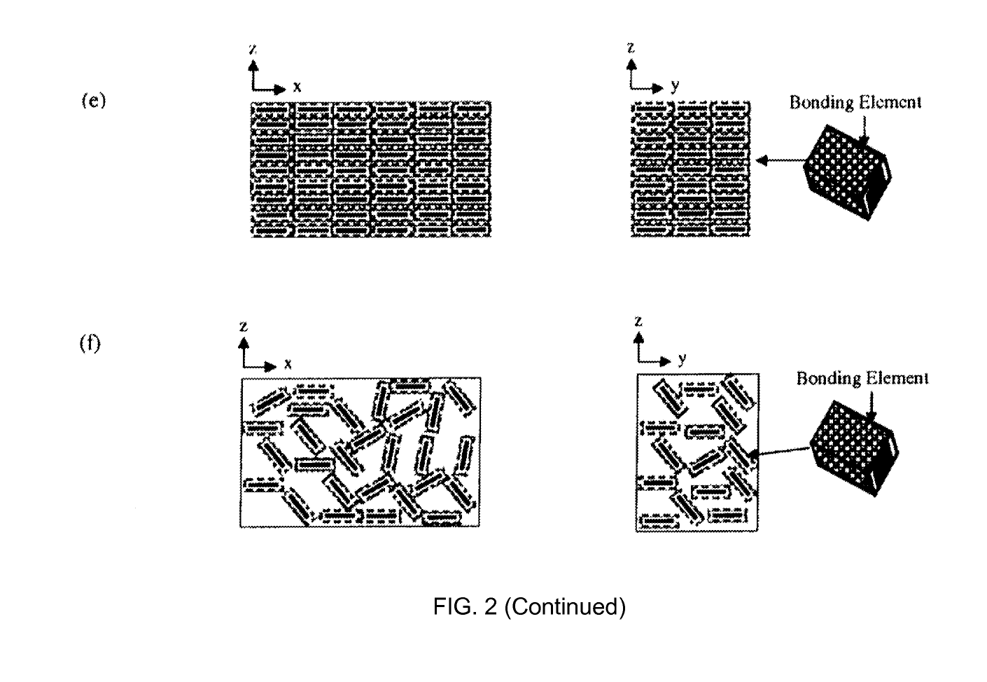

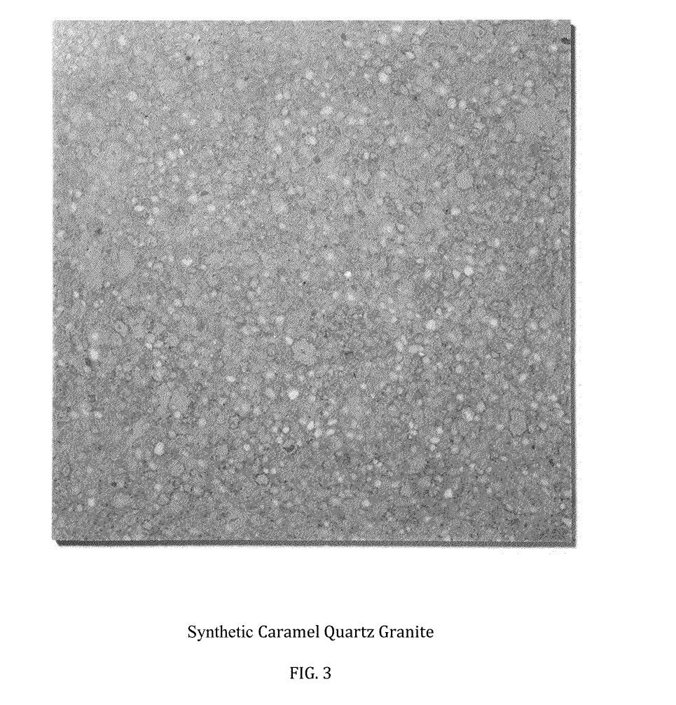

Within the bonding matrix, the bonding elements may be positioned, relative to each other, in any one of a number of orientations. FIGS. 2(a)-2(f) schematically illustrate an exemplary bonding matrix that includes fiber- or platelet-shaped bonding elements in different orientations possibly diluted by the incorporation of filler material, as represented by the spacing between the bonding elements. FIG. 2(a), for example, illustrates a bonding matrix that includes fiber-shaped bonding elements aligned in a one-direction (“1-D”) orientation (e.g., aligned with respect to the x direction). FIG. 2(b) illustrates a bonding matrix that includes platelet-shaped bonding elements aligned in a two-direction (“2-D”) orientation (e.g., aligned with respect to the x and y directions). FIG. 2(c) illustrates a bonding matrix that includes platelet-shaped bonding elements aligned in a three-direction (“3-D”) orientation (e.g., aligned with respect to the x, y and z directions). FIG. 2(d) illustrates a bonding matrix that includes platelet-shaped bonding elements in a random orientation, wherein the bonding elements are not aligned with respect to any particular direction. FIG. 2(e) illustrates a bonding matrix that includes a relatively high concentration of platelet-shaped bonding elements that are aligned in a 3-D orientation. FIG. 2(f) illustrates a bonding matrix that includes a relatively low concentration of platelet-shaped bonding elements that are situated in a random orientation (a percolation network). The composite material of FIG. 2(f) achieves the percolation threshold because a large proportion of the bonding elements are touching one another such that a continuous network of contacts are formed from one end of the material to the other end. The percolation threshold is the critical concentration above which bonding elements show long-range connectivity with either an ordered, e.g., FIG. 2(e), or random orientation, e.g., FIG. 2(f), of bonding elements. Examples of connectivity patterns can be found in, for example, Newnham, et al., “Connectivity and piezoelectric-pyroelectric composites”, Mat. Res. Bull. vol. 13, pp. 525-536, 1978).

Bonding element orientation can be achieved by any one of a number of processes including, for example, tape casting, extrusion, magnetic field and electric field casting. Pre-forming the precursor in accordance with any one of these methods would occur prior to transforming the precursor particle according to the transformation method described above.

Furthermore, one or multi-level repeating hierarchic structure can be achieved in a manner that can promote dense packing, which provides for making a strong material, among other potential useful, functional purposes. Hierarchy describes how structures form patterns on several length scales. Different types of bonding matrices can be created by varying the matrix porosity and by incorporating core fibers of different sizes. Different kinds of particulate and fiber components can be used with hierarchic structures to fabricate different kinds of structures with different connectivity.

### Processes of Forming the Bonding Elements, Bonding Matrices and Composite Materials

The transformation (curing) process proceeds by exposing the precursor material to a reactive liquid. A reactant associated with the liquid reacts with the chemical ingredients that make up the precursor particles, and more specifically, the chemical reactants in the peripheral portion of the precursor particles. This reaction eventually results in the formation of the first and second layers.

In some embodiments, the precursor particles include two or more chemical elements. During the transformation process, the reactant in the liquid preferentially reacts with at least a first one of the chemical elements, wherein the reaction between the reactant in the liquid (e.g., CO₂ and related species in solution) and the at least one first chemical element (e.g., calcium²⁺) results in the formation of the first and second layers, the first layer comprising a derivative of the precursor particle, generally excluding the at least one first chemical element, whereas the second layer comprises a combination (e.g., CaCO₃) of the reactant and the at least one first chemical element. In comparison, the core comprises the same or nearly the same chemical composition as the precursor particle (e.g., CaSiO₃). For example, peripheral portions of the core may vary from the chemical composition of the precursor particle due to selective leaching of particular chemical elements from the core.

Thus, the core and the second layer share the at least one first chemical element (e.g., calcium²⁺) of the precursor particle, and the core and the first layer share at least another one of the chemical elements of the precursor particle (e.g., Si⁴⁺). The at least one first chemical element shared by the core and the second layer may be, for example, at least one alkaline earth element (beryllium, magnesium, calcium, strontium, barium and radium). The at least another one of the chemical elements shared by the core and the first layer may be, for example, silicon, titanium, aluminum, phosphorus, vanadium, tungsten, molybdenum, gallium, manganese, zirconium, germanium, copper, niobium, cobalt, lead, iron, indium, arsenic and/or tantalum.

In some embodiments, the reaction between the reactant in the liquid phase and the at least one first chemical element of the precursor particles may be carried out to completion thus resulting in the first layer becoming the core of the bonding element and having a chemical composition that is different from that of the precursor particles, and at least one additional or second shell layer comprising a composition that may or may not include the at least one first chemical element of the two or more chemical elements of the precursor particles.

### A. Gas-Assisted Hydrothermal Liquid Phase Sintering

The bonding elements may be formed, for example, by a method based on gas-assisted HLPS. In such a method, a porous solid body including a plurality of precursor particles is exposed to a liquid (solvent), which partially saturates the pores of the porous solid body, meaning that the volume of the pores are partially filled with water.

In certain systems such as those forming carbonate, completely filling the pores with water is believed to be undesirable because the reactive gas is unable to diffuse from the outer surface of the porous solid body to all of the internal pores by gaseous diffusion. Instead, the reactant of the reactive gas would dissolve in the liquid and diffuse in the liquid phase from the outer surface to the internal pores, which is much slower. This liquid-phase diffusion may be suitable for transforming thin porous solid bodies but would be unsuitable for thicker porous solid bodies.

In some embodiments, a gas containing a reactant is introduced into the partially saturated pores of the porous solid body and the reactant is dissolved by the solvent. The dissolved reactant then reacts with the at least first chemical element in the precursor particle to transform the peripheral portion of the precursor particle into the first layer and the second layer. As a result of the reaction, the dissolved reactant is depleted from the solvent. Meanwhile, the gas containing the reactant continues to be introduced into the partially saturated pores to supply additional reactant to the solvent.

As the reaction between the reactant and the at least first chemical element of the precursor particles progresses, the peripheral portion of the precursor particle is transformed into the first layer and the second layer. The presence of the first layer at the periphery of the core eventually hinders further reaction by separating the reactant and the at least first chemical element of the precursor particle, thereby causing the reaction to effectively stop, leaving a bonding element having the core as the unreacted center of the precursor particle, the first layer at a periphery of the core, and a second layer on the first layer.

The resulting bonding element includes the core, the first layer and the second layer, and is generally larger in size than the precursor particle, filling in the surrounding porous regions of the porous solid body and possibly bonding with adjacent materials in the porous solid body. As a result, net-shape formation of products may be formed that have substantially the same size and shape as but a higher density than the porous solid body. This is an advantage over traditionally sintering processes that cause shrinkage from mass transport to produce a higher density material than the initial powder compact.

### B. HLPS in an Autoclave

In an exemplary embodiment of the method of HLPS, a porous solid body comprising a plurality of precursor particles is placed in an autoclave chamber and heated. Water as a solvent is introduced into the pores of the porous solid body by vaporizing the water in the chamber. A cooling plate above the porous solid body condenses the evaporated water that then drips onto the porous body and into the pore of the porous solid body, thus partially saturating the pores of the porous solid body. However, the method of introducing water in this example is one of several ways that water can be delivered. For example, the water can also be heated and sprayed.

Meanwhile, carbon dioxide as a reactant is pumped into the chamber, and the carbon dioxide diffuses into the partially saturated pores of the porous body. Once in the pores, the carbon dioxide dissolves in the water, thus allowing the reaction between the precursor particles and the carbon dioxide to transform the peripheral portions of the precursor particles into the first and second layers.

As the reaction between the second reactant and the first layer progresses, the second reactant continues to react with the first layer, transforming the peripheral portion of the first layer into the second layer. The formation of the second layer may be by the exo-solution of a component in the first layer, and such a second layer may be a gradient layer, wherein the concentration of one of the chemical elements (cations) making up the second layer varies from high to low as you move from the core particle surface to the end of the first layer. It is also possible that the second layer can be a gradient composition as well, such as when the layers are either amorphous or made up of solid solutions that have either constant or varying compositions.

The presence of the second layer at the periphery the precursor core eventually hinders further reaction by separating the second reactant and the first layer, causing the reaction to effectively stop, leaving a bonding element having the core, the first layer at a periphery of the core and a second layer on the first layer. The resulting bonding element is generally larger in size than the original precursor particle, thereby filling in the surrounding porous regions of the porous solid body and bonding with adjacent materials of the porous solid body. As a result, the method allows for net-shape formation of products having substantially the same shape as but a higher density than the original porous solid body. This is an advantage over traditionally sintering processes that cause shrinkage from mass transport to produce a higher density material than the initial powder compact.

### C. Infiltration Medium

The infiltration medium used for transportation into at least a portion of the porous matrix includes a solvent (e.g., water) and a reactive species (e.g., CO₂). The solvent can be aqueous or non-aqueous. The solvent can include one or more components. For example, in some embodiments, the solvent can be water and ethanol, ethanol and toluene, or mixtures of various ionic liquids, such as ionic liquids based on alkyl-substituted imidazolium and pyridinium cations, with halide or trihalogenoaluminate anions. Wetting systems are preferred over non-wetting in order to simplify processing equipment.

The solvent should not be chemically reactive with the porous matrix, although the solvent may chemically react with reactive species. The solvent can be removed via a variety of separation methods such as bulk flow, evaporation, sublimation or dissolution with a washing medium, or any other suitable separation method known to one of ordinary skill in the art.

More specifically, the solvent is a liquid at the temperature where the dissolved reactive species react with the porous matrix. This temperature will vary depending on the specific solvent and reactive species chosen. Low temperatures are preferred over higher ones to save energy and simplify processing equipment thereby reducing manufacturing costs.

The role of the solvent contrasts with prior art involving reactive systems, such as, for example, Portland cement, where a solvent such as water reacts with a porous matrix to form products that contain solvent molecules, such as metal hydrates or metal hydroxides, among other precipitation products.

Regardless of the phase of the pure reactive species, the reactive species dissolve in the solvent as neutral, anionic or cationic species. For example, the at least one reactive species can be CO₂, which is a gas at room temperature that can dissolve in water as neutral CO₂ but can create reactive species such as H₃O⁺, HCO₃⁻, H₂CO₃ and CO₃²⁻. Regardless of the initial phase of the reactive species and the solvent in the natural state, the infiltration medium is in a liquid phases in the pores (e.g., interstitial spaces) of a porous matrix.

For example, capillary forces can be used to wick the infiltration medium into a porous matrix spontaneously. This type of wetting occurs when the infiltration medium has a very low contact angle (e.g., <90° C.). In this case, the medium can partially fill (partially saturate) or fully fill (saturate) the pores. The infiltration can also take place in such a manner that the some pores are filled while others are empty and/or partially filled. It is also possible that an infiltrated porous matrix with gradients in pore filling or saturation can be later transformed to one that is uniform via capillary flow. In addition, wetting does not spontaneously occur when the contact angle of the infiltration medium is high (e.g., >90°). In such cases, fluids will not infiltrate the porous matrix unless external pressure is applied. This approach has utility when it is desirable to withdraw the infiltration medium by the release of pressure (e.g., a reaction can be initiated or halted by pressure).

When infiltration is done using spontaneous capillary flow in the pores, the bulk flow ceases when the pores are filled (saturated). During HLPS, the reactive species react with the matrix to form one or more products by the various reactions. The at least one reaction species is depleted from inside the pore space and thus need to be replenished during the course of the reaction. When pores are fully saturated with the infiltration medium, the reactive species must be transported from the infiltration medium external to the porous matrix through the matrix pores. In a quiescent fluid, diffusion is the process by which transport takes place. Thus, for some HLPS methods whose reactions inside the pores are fast relative to all other mass transport processes, the reaction becomes limited by large increases in the porous matrix thickness. In such a case, only the outer portion of the matrix reacts extensively with the reactive species, while inner regions of the porous matrix are either less completely reacted or unreacted. This type of reactions is suitable for preparation of gradient microstructures where the concentrations of products of the HLPS process are higher on the outside portion (near external surface regions) versus the interior of the structure.

### D. Process Selection and Control

When highly exothermic reactions proceed slowly relative to transport of the infiltration medium and the matrix is thermally insulating, entrapped heat can increase the rate of reaction in the interior of the matrix to enable its interior to contain more product phase (i.e., the product of the reaction between the at least one reactive species and a portion of the porous matrix) than its interior. For HLPS processes where reactions isothermally proceed at an intermediate rate relative to mass transport of the infiltration medium, diffusion can continue to supply the pores with reactive species and no gradient in the degree of reaction (or product concentration) will be observed. In such a case, there is little difference in the chemical and/or phase composition from the interior to the exterior of the material of the monolithic structure or body.

In many cases, a uniform microstructure with respect to phase and composition is desirable in the monolithic structure body. Furthermore, it is also desirable to conduct HLPS reactions in a relatively short time frame, for example, where large thick monolithic bodies are required for applications such as for roads or bridges. It is desirable to balance the rate of reaction and mass transport for HLPS processes. The strategy for precursor choice and method of introducing the precursors to comprise the infiltration medium is important. The preferred choice of precursors and method of introducing the infiltration medium is at least in part a function of the sample thickness in the thinnest direction, the time scale considered acceptable for the process and the thermodynamic and kinetic constraints needed for the process to be commercially viable, such as temperature, pressure and composition.

Table 3 summarizes the precursor choice and method of introduction strategies. The porous matrix can be directly infiltrated or the porous matrix may be evacuated prior to any of the infiltration sequences described in the Table 3. Methods are described that use gases as precursors, liquids as precursors or solids as precursors. In addition, phase mixtures such as solid and liquids, gases and liquids and gas and solids can all be used. For example, a reactant such as CO₂ is a gas in its pure state but is converted to a solution species dissolved into water. Such an event can come about by gaseous diffusion into the porous matrix and subsequent condensation when a pore is encountered. This type of precursor system is relevant when microstructures having carbonate phases are desired. The order of addition of the precursors (solvent and reactive species) can influence the reaction yield and microstructure of the material.

TABLE 3
Precursors and Methods of Introduction for HLPS Processes

| | Reactive | | Deliquescent | |
|---|---|---|---|---|
| System | Species | Solvent | Material | Methods of Introduction |
| (1) | Gas | Gas | | Premixing (parallel introduction) two gases |
| | | | | and introducing them to a lower |
| | | | | temperature to condense one or more gas |
| | | | | species in the matrix to comprise an |
| | | | | infiltrating solution containing reactive |
| | | | | species and solvent or condense the gas |
| | | | | mixture in the matrix by cooling the matrix |
| | | | | or utilize a porous matrix that possesses |
| | | | | Kelvin pores to condense the gas phase in the |
| | | | | matrix. |
| | | | | Gases can also be introduced in series where |
| | | | | one gas is condensed prior to infiltration or |
| | | | | after infiltration and the other is introduced |
| | | | | afterwards to dissolve in the liquid phase. |
| | | | | The reverse order is possible but the |
| | | | | reaction yield could be reduced. |
| (2) | Gas | Gas | Solid | Pre-mixing deliquescent solid with matrix, |
| | | | | pre-mix gases (parallel introduction) then |
| | | | | flow and/or diffuse the gas mixture through |
| | | | | the matrix to form infiltrating solution |
| | | | | Gases can be introduced in series into the |
| | | | | deliquescent solid-matrix pre-mixture. The |
| | | | | preferred order is to have the gas that |
| | | | | liquefies the deliquescent solid and then the |
| | | | | gas that dissolves to form reactive species. |
| | | | | The reverse order is acceptable but the |
| | | | | reaction yield could be reduced |
| (3) | Gas | Liquid | Solid | Premixing of deliquescent solid with matrix, |
| | | | | then infiltrate with liquid solvent, then add |
| | | | | gas (or visa-versa) to form infiltrating |
| | | | | solution in matrix pores. Reverse order of |
| | | | | gas and liquid is possible but may result in |
| | | | | reduced reaction yield |
| | | | | or |
| | | | | Gas and liquid could be pre-mixed as a |
| | | | | solution for introduction into the |
| | | | | deliquescent solid-matrix pre-mixture but |
| | | | | reaction yield might be reduced |
| (4) | Liquid | Liquid | | Pre-mix (parallel introduction) fluids then |
| | | | | infiltrate matrix. |
| | | | | or |
| | | | | Infiltrate fluids through matrix in series with |
| | | | | preferred ordering being liquid solvent prior |
| | | | | to liquid that provides reactive species. |
| (5) | Liquid | Liquid | Solid | Premixing of deliquescent solid with |
| | | | | matrix, then add liquid solvent to dissolve |
| | | | | deliquescent solid, then add liquid reactive |
| | | | | species (or visa-versa) to form infiltrating |
| | | | | solution. |
| | | | | or |
| | | | | Pre-mixed solvent and reactive |
| | | | | species in liquid phases as an infiltration |
| | | | | solution for introduction into the |
| | | | | deliquescent solid-matrix pre-mixture |
| (6) | Liquid | Gas | | Infiltrate matrix with gas and |
| | | | | condense in matrix as liquid, then infiltrate |
| | | | | second liquid into matrix to mix with first |
| | | | | liquid in matrix. Reverse order is also |
| | | | | possible but not preferred due to possibility |
| | | | | of low reaction yield. |
| | | | | or |
| | | | | Preferred route is premixing of gas |
| | | | | and liquid by condensing gas and mixing into |
| | | | | second liquid, then introduce solution to a |
| | | | | porous matrix |
| (7) | Gas | Liquid | — | Infiltrate liquid then introduce gas or |
| | | | | Pre-dissolve gas in liquid then infiltrate |
| (8) | Solid | Solid | | Mix solids with porous matrix, then |
| | | | | pressurize or heat to form infiltration liquid. |
| | | | | One solid may flux the other to form a liquid |
| | | | | phase that can be removed later by washing. |
| | | | | Other solids could be added to reduce |
| | | | | melting temperature to form liquid phase as |
| | | | | long as it can be removed later |
| (9) | Liquid | Solid | | Prepare infiltration solution by dissolving |
| | | | | solid in liquid, then infiltrate |
| | | | | Or |
| | | | | Premix solid with porous matrix, then |
| | | | | infiltrate with liquid |
| (10) | Solid | Liquid | | Prepare infiltration solution by dissolving |
| | | | | solid in liquid, then infiltrate |
| | | | | Or |
| | | | | Premix solid with porous matrix, then |
| | | | | infiltrate with liquid |

In some embodiments, the solvent and reactive species may be premixed to form the infiltration medium and then introduced into the matrix in a single step. In other embodiments, it may be preferable to employ multiple infiltration sequences. For example, the solvent precursor could be introduced first followed by infiltration of the reactive species or vice versa.

Neither the solvent nor the reactive species precursors need to be the same phase initially as the infiltrating medium will be a liquid that is found in the pores of the matrix. For example, the solvent precursor can be a vapor such as water, which is gaseous at temperatures at 100° C. or higher at atmospheric pressure and can be condensed to a liquid by cooling the matrix to a temperature lower than 100° C. or utilizing surface energy by using porous matrices with pore sizes in the Kelvin pore-size range (less than 100 nm). When the pores are large, the temperature is elevated such that gaseous species cannot be thermally condensed, small amounts of infiltrating solution are needed or other reasons not discussed here, and it may be desirable to form the liquid in the pore using a deliquescent compound. Examples of such compounds include boric acid, iron nitrate, and potassium hydroxide. In this case, a vapor such as water can convert the deliquescent solid phase in the pore to a liquid and crystal growth of the product phase can proceed in the pore. This is particularly useful when liquid infiltration and diffusion limits the thickness of the product made by HLPS. Alternatively, gaseous diffusion can be used to transport species over much large distances to form the infiltration medium required for HLPS inside of the pores of the matrix.

Various additives can be incorporated to improve the HLPS process and the resulting products. Additives can be solids, liquids or gases in their pure state but either soluble in the solvent phase or co-processed (e.g., pre-mixed) with the porous matrix prior to incorporation of the infiltration medium. Examples include nucleation catalysts, nucleation inhibition agents, solvent conditioners (e.g., water softening agents), wetting agents, non-wetting agents, cement or concrete additives, additives for building materials, crystal morphology control additives, crystal growth catalysts, additives that slow down crystal growth, pH buffers, ionic strength adjusters, dispersants, binders, rheological control agents, reaction rate catalysts, electrostatic, steric, electrosteric, polyelectrolyte and Vold-layer dispersants, capping agents, coupling agents and other surface-adsorptive species, acid or base pH modifiers, additives generating gas, liquids or solids (e.g., when heated, pressurized, depressurized, reacted with another species or exposed to any processing variable no listed here), and biological or synthetic components (e.g., serving any of the above functions and/or as a solvent, reactive species or porous matrix).

In some embodiments, a deliquescent solid may be used. The deliquescent solid may be premixed with the porous matrix. Then pre-mixture of the solvent and at least one reactive species can be introduced to the deliquescent solid-porous matrix. The solvent and at least one reactive species in the pre-mixture can be both in the gaseous phase or both in liquid phases. In some embodiments, the solvent may be a liquid and the at least one reactive species may be in a gaseous phase in the pre-mixture or vice versa.

A gas-water vapor stream can be passed over a deliquescent salt in the porous matrix to generate the infiltrating medium in a liquid phase in the interstitial space in the porous matrix. For example, a humid gas-water vapor stream can serve as a solvent for CO₂ dissolution and ionization. A large number of salts are known to be deliquescent and can be used suitable for forming liquid solutions from the flow of humid air over the salt surfaces. Selection of the appropriate salt relies on the level of humidity in the air. Some salts can operate at very low relative humidities. Examples of deliquescent slats include Mg(NO₃)₂, CaCl₂ and NaCl.

Regarding delivery of the infiltration medium, it can be delivered as a bulk solution that spontaneously wets the porous matrix. There are many options for delivery of this solution. First, the porous matrix can be immersed in the liquid. Second the infiltration solution can be sprayed onto the porous matrix. In a quiescent system, when there is a volume of infiltration solution that is greater than the pore volume of the porous matrix, diffusion propagates the reaction by delivering the reactive species to the pore sites.

Alternatively, the fluid can flow (mechanically convected) through the porous matrix by a variety of methods. Methods such as pressurized flow, drying, electro-osmotic flow, magneto-osmosis flow, and temperature- and chemical-gradient-driven flow can be used to flow the liquid infiltration medium through the porous body. This dynamic flow allows fresh reactant to be near the porous matrix, as opposed to relying on diffusional processes. This approach is beneficial as long as the pore size distribution of the matrix permits a reasonably high flow rate of a fluid that supplies reactive species faster than a diffusional process and is optimal when the supply rate equals or exceeds the reaction rate for product formation. In addition, flow-through of the infiltration medium is especially useful for highly exothermic reactions. This is particularly beneficial for monolithic structures that are thick and can generate heat internally capable of generating internal pressures capable of fracturing the monolithic structure.

There are many applications where thicknesses of materials exceed this length scale. In these cases, mechanical convection of the fluid by any suitable means known to one of skill in the art is preferred. An alternative is to introduce the solvent or reactive species as a gaseous species. Also, supercritical conditions can be employed to achieve transport rates that lie between liquids and gases. Gas species may be mechanically convected by applying a pressure gradient across the porous matrix. If the gas is a reactive species, pores filled with solvent fluid can flow out of the pores leaving behind a film of solvent on the pores that can absorb the reactive species gas. Alternatively, partially filled pores will allow gas to flow through the pores as the solvent absorbs a portion of the gas flowing through.

A system may utilize low temperatures and low pressures to enable a low cost process. Thus, processes that retain a fraction of solvent in the pores to facilitate gaseous diffusion of reactive species are preferred over those that utilize quiescent fluids for reactions where a large fraction of product is desired. There are many apparatus designs that can effectively transport reactant and solvent species to the pores. Some of these designs involve conventional reactor equipment such as filter presses, spray chambers, autoclaves and steamers.

### EXAMPLES

### Example 1

### Caramel Quartz Granite

Raw Materials:

NYAD® 400—Wollastonite, Willsboro, N.Y. (Nyco Minerals); Caramel Quartz-crushed quartz, Mosinee, Wis. (Kafka Granite); Mason Sand-fine sand, Lakewood, N.J. (Clayton Sand); Deionized water; Acumer™ 9400-dispersant (Rohm Haas); Welan Gum-polysaccharide gum (Fritz Industries)

TABLE 4
Mixing Proportions (40 kg batch size)

| | | | |
|---|---|---|---|
| Solid Components: | 91.21% | | |
| NYAD ® 400 | 24.62% | 9.32 | kg |
| Caramel Quartz | 43.21% | 16.36 | kg |
| Mason Sand | 32.18% | 12.18 | kg |
| Liquid Components: | 8.79% | | |
| Deionized water | 98.9% | 3.61 | kg |
| Acumer ™ 9400 | 1% | 36.5 | g |
| Welan Gum | 0.1% | 3.65 | g |

Mixing Procedure:

9.32 kg of NYAD® 400, 16.32 kg of Caramel Quartz and 12.18 kg of Mason were gathered into separate buckets. All solid components were loaded into the drum mixer. The powders were then blended in the drum mixer for 2 minutes creating a dry mix.

A liquid solution consisting of deionized water (3.61 kg) and Welan Gum (3.65 g) was prepared by adding the Welan Gum to the water while stirring the water. The liquid solution was then added to the dry mix by pouring the liquid solution into the drum mixer. The drum mixer, containing both the dry mix and the liquid solution, was run for 3.5 minutes.

The Acumer™ 9400 (36.5 g) was then added to the drum mixer. The drum mixer, containing the dry mix, the liquid solution and the Acumer, was run for an additional 3.5 minutes, creating a wet mix.

Casting Procedure:

A 5 ft×2 ft aluminum mold was lubricated by spraying WD-40 on a rag and wiping the surface of the mold. The lubricated mold was clamped onto a Vibco vibration table. The wet mix was scooped from the drum mixer into the mold until the mold was approximately half full. The mold was vibrated at maximum frequency until the wet mix was distributed evenly throughout the mold. A second layer of wet mix was then added to the mold and the vibration was repeated. Additional wet mix was added to the vibrating mold until the mold was filled to the brim. A piece of Fibatape® Crackstop™ mesh, cut to fit the inside perimeter of the mold, was then placed over the surface of the wet mix and rubbed in to prevent cracking during drying.

Drying Procedure:

The cast wet mix within the mold was weighed, transported into a drying oven set at 90 C and dried for 24 hours to create a green ceramic body within the mold.

Curing Procedure:

The green ceramic body within the mold was placed inside a 7 ft diameter, 12 ft long, horizontal, autoclave. The autoclave, which had been pre-heated to 90° C., was evacuated to a pressure of −14 psig in 15 min. The autoclave was then back filled with CO₂ gas and steam heated to 147.5° C. The CO₂ source was cut off when the total pressure reached 10 psig. The autoclave temperature was set to 90° C. and hot water at 115° C. was circulated at the bottom of the autoclave to keep the unit saturated with water vapor. The system was allowed to equilibrate for 45 min. (total psi reaching approximately 16 psig). The autoclave pressure was then increased to 20 psig by filling with heated CO₂ gas only.

The green ceramic body was cured by subjecting it to a wetting/drying processes. During the wetting process, the green ceramic body was sprayed with water, of droplet size less than 50 microns and heated to 90° C., at a rate of 0.036 gallons per minute for 3 hours. During the drying process, CO₂ pressure was reduced to 10 psig and coolant was passed through a chiller coil within the autoclave to promote the removal of water from the samples. The samples were dried for 20 hours.

The wetting/drying processes were then repeated to produce a fully cured ceramic body.

The cured ceramic body was removed from the autoclave and placed in an industrial dying oven at 90° C. to remove any residual water. The extent of the reaction was calculated based on the weight gain during the reaction. The average extent of reaction was 80%.

Photograph:

FIG. 3 shows an exemplary photograph of a synthetic caramel quartz granite prepared according to an embodiment of the present invention.

Compressive Strength Testing:

Compressive strength was measured according to American Society for Testing and Materials (ASTM) C-67, section 7. Samples for compressive strength testing were prepared by saw cutting cube-shaped test pieces from the cured ceramic body. The edge dimension of the cube was dictated by the thickness of the original slab specimen. Saw-cut cubes were dried overnight in an oven at 90° C.

Compressive strength was measured on 150 kN Instron mechanical tester at a strain rate of 0.5 mm/min. A total of 8 samples were tested. The mean compressive strength was 141.8 MPa with a standard deviation of 32 MPa.

Flexural Strength Testing:

Flexural strength was measured according to ASTM C-67, section 6. Samples for flexural strength testing were prepared by saw cutting rectangular-shaped test pieces from the cured ceramic body. The rectangular-shaped test pieces were 20 cm long, 10 cm wide and with a thickness dictated by the thickness of the original slab specimen. Saw-cut rectangles were dried overnight in an oven at 90° C.

Flexural strength was measured on 150 kN Instron mechanical tester equipped with a 3-point flexural strength rig at a strain rate of 0.5 mm/min. A total of 5 samples were tested. The mean flexural strength was 18.8 MPa with a standard deviation of 1.8 MPa.

Water Absorption:

Water absorption was measured according to ASTM C-67, section 8. Samples for water absorption testing were prepared by saw cutting cube-shaped test pieces from the cured ceramic body. The edge dimension of the cube was dictated by the thickness of the original slab specimen. Saw-cut cubes were dried overnight in an oven at 90° C.

The dry weight of each cube was measured. The cubes were then submerged for 24 hours in water at typical lab temperature (15-30° C.), removed from the water, wiped clean of surface moisture, and weighed a second time (saturated weight).

The saturated cubes were then re-submerged in water. The water was brought to a boil, held at the boiling point for 5 hours and then cooled back to typical lab temperature. The cubes were then removed from the water, wiped clean of surface moisture, and weighed a third time (5-hour boil saturated weight).

The saturated cubes were dried overnight in an oven at 90° C. and weighed for a fourth time, to assure that no material loss occurred during the saturation and boiling steps.

Water absorption is defined as the percentage weight gain when the 5-hour boil saturated weight is compared to the dry weight for each cube. A total of 24 samples were tested. The mean water absorption was 4.2% with a standard deviation of 0.4%.

### Example 2

### Natural Golden Crema® Granite

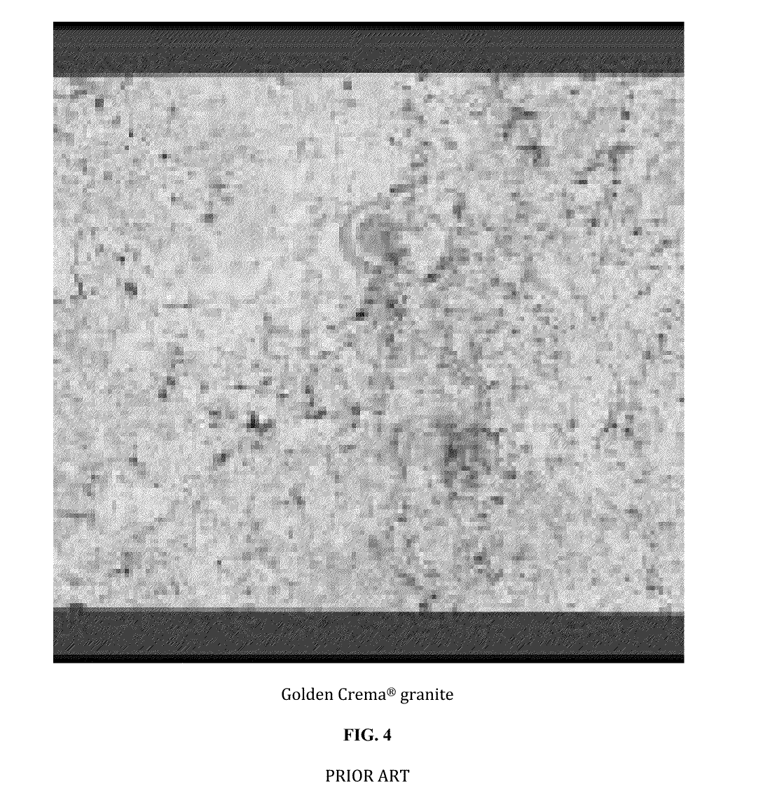

FIG. 4 shows a Golden Crema® granite slab acquired from Fairfield County Stone, Bridgeport, Conn.

Compressive Strength Testing:

Compressive strength was measured according to ASTM C-67, section 7. Samples for compressive strength testing were prepared by saw cutting cube-shaped test pieces from the granite slab. The edge dimension of the cube was dictated by the thickness of the original slab specimen. Saw-cut cubes were dried overnight in an oven at 90° C.

Compressive strength was measured on 150 kN Instron mechanical tester at a strain rate of 0.5 mm/min. A total of 4 samples were tested. The mean compressive strength was 110.8 MPa with a standard deviation of 19.2 MPa.

Flexural Strength Testing:

Flexural strength was measured according to ASTM C-67, section 6. Samples for flexural strength testing were prepared by saw cutting rectangular-shaped test pieces from the granite slab. The rectangular-shaped test pieces were 20 cm long, 10 cm wide and with a thickness dictated by the thickness of the original slab specimen. Saw-cut rectangles were dried overnight in an oven at 90° C.

Flexural strength was measured on 150 kN Instron mechanical tester equipped with a 3-point flexural strength rig at a strain rate of 0.5 mm/min. A total of 6 samples were tested. The mean flexural strength was 6.5 MPa with a standard deviation of 1.1 MPa.

### Example 3

### Green Glass Granite

Raw Materials:

NYAD® 400-Wollastonite, Willsboro, N.Y. (Nyco Minerals); Green Glass 01—crushed green glass size 01, North Salt Lake, Utah (American Specialty Glass); Green Glass 00—crushed green glass size 00, North Salt Lake, Utah (American Specialty Glass); Clear Glass-crushed clear glass size 30×70, North Salt Lake, Utah (American Specialty Glass); MM Precipitated Calcium Carbonate-precipitated calcium carbonate, Lucerne Valley, Calif. (Specialty Minerals); Chrome Green-green pigment, Los Angeles, Calif. (Davis Colors); Deionized water; Acumer™ 9400-dispersant (Rohm Haas).

TABLE 5
Mixing Proportions (180 kg batch size)

| | | | |
|---|---|---|---|
| Solid Components: | 91.15% | | |
| NYAD ® 400 | 25.8% | 42.41 | kg |
| Green Glass 01 | 35.5% | 58.40 | kg |
| Green Glass 00 | 23.6% | 38.93 | kg |
| Clear Glass | 11.8% | 19.46 | kg |
| MM Precipitated Calcium | 1.8% | 3.0 | kg |
| Carbonate | | | |
| Chrome Green | 1.5% | 2.47 | kg |
| Liquid Components: | 8.85% | | kg |
| Deionized water | 99% | 15.14 | kg |
| Acumer ™ 9400 | 1% | 153 | g |

Mixing Procedure:

42.41 Kg of NYAD® 400, 58.40 kg of Green Glass 01, 38.93 kg of Green Glass 00, 19.46 kg of Clear Glass, 3.0 kg of MM Precipitated Calcium Carbonate and 2.47 kg of Chrome Green were gathered into separate buckets. All solid components were loaded into the drum mixer. The powders were then blended in the drum mixer for 2 minutes creating a dry mix.

A liquid solution consisting of deionized water (15.14 kg) and Acumer™ 9400 (153 g) was prepared by adding the Acumer to the water while stirring the water. The liquid solution was then added to the dry mix by pouring the liquid solution into the drum mixer. The drum mixer, containing both the dry mix and the liquid solution, was run for an additional 3.5 minutes to create a wet mix.

Casting Procedure:

A 5 ft×2 ft aluminum mold was lubricated by spraying WD-40 on a rag and wiping the surface of the mold. The lubricated mold was clamped onto a Vibco vibration table. The wet mix was scooped from the drum mixer into the mold until the mold was approximately half full. The mold was vibrated at maximum frequency until the wet mix was distributed evenly throughout the mold. A second layer of wet mix was then added to the mold and the vibration was repeated. Additional wet mix was added to the vibrating mold until the mold was filled to the brim. A piece of Fibatape® Crackstop™ mesh, cut to fit the inside perimeter of the mold, was then placed over the surface of the wet mix and rubbed in to prevent cracking during drying.

Drying Procedure:

The cast wet mix within the mold was weighed, transported into a drying oven set at 90 C and dried for 24 hours to create a green ceramic body within the mold.

Curing Procedure:

The green ceramic body within the mold was placed inside a 7 ft diameter, 12 ft long, horizontal, autoclave. The autoclave, which had been pre-heated to 90° C., was evacuated to a pressure of −14 psig in 15 min. The autoclave was then back filled with CO₂ gas and steam heated to 147.5° C. The CO₂ source was cut off when the total pressure reached 10 psig. The autoclave temperature was set to 90° C. and hot water at 115° C. was circulated at the bottom of the autoclave to keep the unit saturated with water vapor. The system was allowed to equilibrate for 45 min. (total psi reaching approximately 16 psig). The autoclave pressure was then increased to 20 psig by filling with heated CO₂ gas only.

The green ceramic body was cured by subjecting it to a wetting/drying processes. During the wetting process, the green ceramic body was sprayed with water, of droplet size less than 50 microns and heated to 90° C., at a rate of 0.036 gallons per minute for 3 hours. During the drying process, CO₂ pressure was reduced to 10 psig and coolant was passed through a chiller coil within the autoclave to promote the removal of water from the samples. The samples were dried for 20 hours.

The wetting/drying processes were then repeated to produce a fully cured ceramic body.

The cured ceramic body was removed from the autoclave and placed in an industrial dying oven at 90° C. to remove any residual water. The extent of the reaction was calculated based on the weight gain during the reaction. The average extent of reaction was 75%.

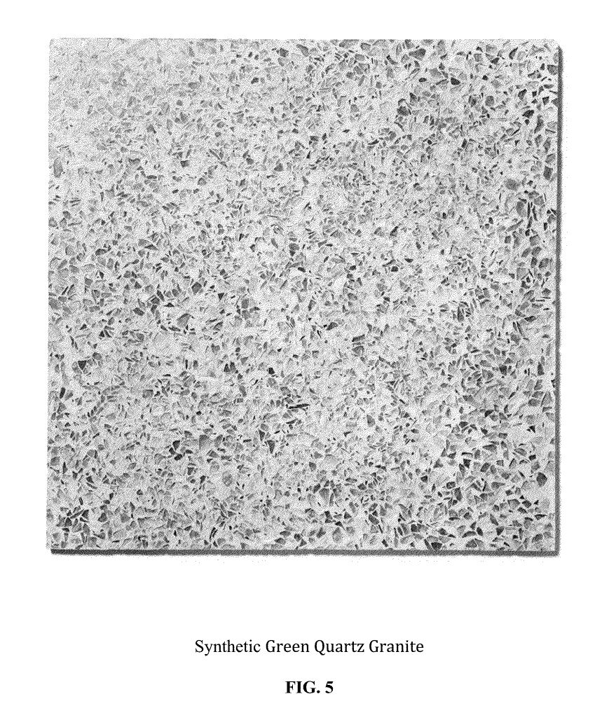

FIG. 5 shows an exemplary photograph of a synthetic caramel quartz granite prepared according to an embodiment of the present invention.

### Other Colors

It is believed that other colors can be produced by incorporating colored glass or colored quartz having colors other than green, including by way of example one or more colors selected from black, white, blue, gray, pink, red, yellow and brown, and combinations thereof.

### Example 4

### Alternative Curing Processes

Curing Procedure

(Steaming at 90° C. and 20 psig). The green ceramic body within the mold was placed inside a 7 ft diameter, 12 ft long, horizontal, autoclave, which had been pre-heated to 90° C. The autoclave was evacuated to a pressure of −14 psig in 15 min. The autoclave was then back filled with CO₂ gas and steam heated to 147.5° C. The CO₂ source was cut off when the total pressure reached 10 psig. The autoclave temperature was set to 90° C. and hot water at 115° C. was circulated at the bottom of the autoclave to keep the unit saturated with water vapor. The system was allowed to equilibrate for 45 min. (total psi reaching approximately 16 psig). The autoclave pressure was then increased to 20 psig by filling with heated CO₂ gas only. The green ceramic body was cured under these conditions for 19 hours. The cured ceramic body was removed from the autoclave and placed in an industrial dying oven at 90° C. to remove any residual water. The extent of the reaction was calculated based on the weight gain during the reaction. The average extent of reaction was 50%.

### Example 5

### Alternative Curing Processes

Curing Procedure

(Steaming at 60° C. and 0 psig (atmospheric pressure)): The green ceramic body within the mold was placed inside a 7 ft diameter, 12 ft long, horizontal, autoclave, which had been pre-heated to 60° C. The autoclave was then purged with CO₂ gas heated to 75° C. Bleed-valves at the top and bottom of the autoclave were left in the open position to facilitate CO₂ gas flow through the autoclave. During the CO₂ purge, the atmosphere within the autoclave was stirred by a fan. After 5 min., the CO₂ gas flow was terminated, the two bleed-valves were shut, and the fan was turned off. The bleed-valve at the top of the autoclave was then opened and the CO₂ gas flow was resumed for an additional 10 min. This allowed the lighter air to escape through the top bleed-valve and created a near 100% CO₂ atmosphere within the autoclave. The bleed-valve at the top of the autoclave was then closed, the fan was turned on, and the CO₂ pressure within the autoclave was regulated to 0.5 psig. Water, preheated to 75° C., was circulated at the bottom of the reactor to allow for water vapor pressure to build within the autoclave. Once the atmosphere within the autoclave reaches 60° C., the gas concentrations are approximately 84% CO₂ and 16% H₂O vapor. The green ceramic body was cured under these conditions for 19 hours. The cured ceramic body was removed from the autoclave and placed in an industrial dying oven at 90° C. to remove any residual water. The extent of the reaction was calculated based on the weight gain during the reaction. The average extent of reaction was 60%.

In this specification and the appended claims, the singular forms “a,” “an,” and the include plural reference, unless the context clearly dictates otherwise.

Unless defined otherwise, all technical and scientific terms used herein have the same meaning as commonly understood by one of ordinary skill in the art. Although any methods and materials similar or equivalent to those described herein can also be used in the practice or testing of the present disclosure, the preferred methods and materials are now described. Methods recited herein may be carried out in any order that is logically possible, in addition to a particular order disclosed.

### INCORPORATION BY REFERENCE

References and citations to other documents, such as patents, patent applications, patent publications, journals, books, papers, web contents, have been made in this disclosure. All such documents are hereby incorporated herein by reference in their entirety for all purposes. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

### Equivalents

The representative examples disclosed herein are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples which follow and the references to the scientific and patent literature cited herein. The following examples contain important additional information, exemplification and guidance that can be adapted to the practice of this invention in its various embodiments and equivalents thereof.

What is claimed is:

1. A composite material comprising:
a plurality of bonding elements, wherein each bonding element comprises:
a core comprising primarily calcium silicate,
a silica-rich first or inner layer, and
a calcium carbonate-rich second or outer layer; and
a plurality of filler particles comprising coarse filler particles and fine filler particles,
wherein the plurality of bonding elements and the plurality of filler particles together form one or more bonding matrices and the bonding elements and the filler particles are substantially evenly dispersed therein and bonded together, whereby the composite material exhibits one or more substantially granite-like textures, patterns and physical properties.

2. The composite material of claim 1, further comprising a colorant.

3. The composite material of claim 2, wherein the colorant is a pigment comprising a metal oxide.

4. The composite material of claim 2, wherein the colorant is a glass material having a color selected from black, white, blue, gray, pink, green, red, yellow and brown.

5. The composite material of claim 1, wherein
the plurality of bonding elements have a median particle size in the range from about 5 μm to about 100 μm.

6. The composite material of claim 1, wherein the coarse filler particles are made from a silicon dioxide-rich material.

7. The composite material of claim 1, wherein the plurality of bonding elements are chemically transformed from ground wollastonite.

8. The composite material of claim 1, wherein the weight ratio of bonding elements:filler particles is about 15-50:50-85.

9. The composite material of claim 2, wherein the pigment is present in an amount from 0% to about 10% by weight.

10. The composite material of claim 1, having a compressive strength from about 90 MPa to about 175 MPa and a flexural strength from about 5.4 MPa to about 20.6 MPa.

11. The composite material of claim 1, exhibiting a visual pattern unique to granite.

12. A process for preparing a composite material, comprising the steps of:
mixing a particulate composition and a liquid composition to form a slurry mixture, wherein the particulate composition comprises:
a ground calcium silicate having a median particle size in the range from about 1 μm to about 100 μm, and
a plurality of filler particles comprising coarse particles and fine particles,
and wherein the liquid composition comprises:
water, and
a water-soluble dispersant;
casting the slurry mixture in a mold; and
curing the casted mixture at a temperature in the range from about 20° C. to about 150° C. for about 1 hour to about 80 hours under an atmosphere of water and CO₂ having a pressure in the range from ambient atmospheric pressure to about 60 psi above ambient and having a CO₂ concentration ranging from about 10% to about 90% to produce a composite material exhibiting a granite-like texture and pattern.

13. The process of claim 12, further comprising, before the step of curing the casted mixture:
the step of drying the casted mixture.

14. The process of claim 12, wherein the step of curing the casted mixture is performed at a temperature equal to or lower than about 60° C. for about 15 to about 50 hours under a vapor comprising water and CO₂ and having an ambient atmospheric pressure.

15. The process of claim 12, wherein
the ground calcium silicate comprises ground wollastonite, and
the plurality of filler particles comprising coarse particles and fine particles comprise a silicon dioxide-rich material.

16. The process of claim 15, wherein
the plurality of filler particles comprising coarse particles and fine particles comprise one or more of quartz, mica and feldspar.

17. The process of claim 12, wherein the liquid composition comprises:
water, and
a water-soluble dispersant comprising a polymer salt having a concentration from about 0.1% to about 2% w/w of the liquid composition.

18. The process of claim 17, wherein
the polymer salt is an acrylic homopolymer salt.

19. The process of claim 12, wherein the particulate composition comprises about 25% w/w of ground calcium silicate, and about 70% to about 75% w/w of the silicon dioxide-based material.

20. A composite material comprising:
a plurality of bonding elements, wherein each bonding element comprises:
a core comprising primarily magnesium silicate,
a silica-rich first or inner layer, and
a magnesium carbonate-rich second or outer layer; and
a plurality of filler particles,
wherein the plurality of bonding elements and the plurality of filler particles together form one or more bonding matrices and the bonding elements and the filler particles are substantially evenly dispersed therein and bonded together, whereby the composite material exhibits one or more substantially granite-like textures, patterns and physical properties.
